(19) United States
(12) Patent Application Publication
(10) Pub. No.: US 2006/0017540 A1
(43) Pub. Date: Jan. 26, 2006

(54) Fuse blow-out dual LED indicator

(76) Inventor: Jerry L. Smith, Hesperia, CA (US)

Correspondence Address: Donald W. Meeker;Patent Agent, 924 East Ocean Front #E, Newport Beach, CA, 92661, US

(21) Appl. No.: 11/071,612

(22) Filed: Mar. 3, 2005

Related U.S. Application Data
(60) Provisional application No. 60/590,949, filed on Jul. 26, 2004.

(51) Int. Cl. H01H 85/30; H01H 85/32

(52) U.S. Cl. 337/242

(57) ABSTRACT

A dual bipolar LED indicator light circuit is connected between the blades of a blade fuse in parallel with the fuse link. When the fuse link blows, one of the LEDs lights to indicate a blown fuse. Parallel dual bipolar light emitting diode (LED) indicators are in series with an integrated resistor. The fuse may be inserted in either direction without concern for polarity. The indicator light circuit may be built into a blade fuse, or snapped onto an existing blade fuse as an attachment.

### CLAIM OF PROVISIONAL APPLICATION RIGHTS

This application claims the benefit of U.S. Provisional Patent Application No. 60/590,949, filed on Jul. 26, 2004.

### BACKGROUND OF THE INVENTION

1. Field of the Invention

The present invention relates to overcurrent protection devices and particularly to a blade fuse having a dual bipolar light emitting diode (LED) indicator and an integrated resistor for showing if the fuse is opened or blown, which allows the fuse to be inserted in either direction and which may be built into a blade fuse or snapped onto a blade fuse as an attachment.

2. Description of the Prior Art

Fuses are widely used as overcurrent protection devices to protect the wiring and battery to prevent costly damage to electrical circuits. Fuse terminals typically form an electrical connection between an electrical power source and an electrical component or a combination of components arranged in an electrical circuit.

Electrical equipment used in the automotive industry is generally protected from electrical current overload by disposable fuses. Such fuses are most often composed of a transparent housing with two conductive terminals joined by a meltable link. When a fuse reaches overload, the link melts due to high heat caused by excessive current moving through the fuse, this in turn interrupts the electrical circuit and the electrical equipment previously supplied with electricity ceases to function. The equipment operator must then inspect the fuses to see if any of the fuses are blown and determine if the failure is fuse related or equipment related.

Prior art attempts to provide a better visual indicator of a blown fuse do not provide an indicator light means that will light independent of polarity no matter how the fuse is installed.

U.S. Patent Application #20020149464, published Oct. 17, 2002 by Santa Cruz, shows an indicator light for use in combination with an electrical circuit protector or fuse, which will automatically illuminate to notify a user that an electrical overload has occurred.

U.S. Pat. No. 4,695,815, issued Sep. 22, 1987 to Hwang, shows an automobile fuse with damage indicator, in which two conductors of a small indicator bulb are connected in parallel with two conductors of a fusible link so that the bulb does not light as long as the fuse is in good condition; but will light immediately by current passing through the load after the fusible link is broken by an overload. The lighting of an indicator at the place where the fuse is installed directly indicates a burnt fuse, particularly at night or in a dark place and trouble shooting and replacement of fuse can be conducted quickly. (see FIG. 3)

U.S. Pat. No. 4,499,447, issued Feb. 12, 1985 to Greenberg, provides a blade terminal fuse with an integrity indicator. The integrity indicator is formed as an illuminable bead that is combined with the pair of flat terminal blades of a miniature plug-in fuse and is positioned in a central window provided in the top wall of the insulator housing thereof. The housing defines a chamber having an open bottom and a central section with relatively narrow lateral sections in which upper portions of the blades are secured. A fuse-wire extends across the central section conductively interconnecting the blades. The illuminable bead has a pair of wire leads extending oppositely into the lateral sections of the chamber, each wire lead conductively contacting the upper portion of one of the blades and connecting the bead in parallel circuit with the fuse-wire. Clamping components formed on the interior of the top wall and on the upper portion of each terminal blade secure each wire lead in operative position. Embodiments include the fuse-wire integrally formed with the blades as a unitary structure and formed separately as a three piece structure wherein opposite ends of the fuse-wire are also secured by the clamping components, the latter being either in coplanar relation with the blades or disposed perpendicular to the plane of the blades. Illuminable bead 27, as seen in FIG. 11, may comprise a pair of LEDs 28 arranged in parallel in opposite polarity and in series with a protecting resistor 27a all encased in suitable translucent material, such as, epoxy, glass or the like, in accordance with conventional solid state technology and has a pair of oppositely extending wire leads 29.

U.S. Pat. No. 4,712,081, issued Dec. 8, 1987 to Bosley, is for a blade fuse assembly with indicator, which is arranged to glow brightly when the fuse blows. The fuse incorporates a bulb positioned snugly in a pocket in a base of the fuse housing, the bulb being connected electrically in parallel with fusible metal strip.

U.S. Pat. No. 5,004,995, issued Apr. 2, 1991 to Lo, claims a fuse assembly for a car that incorporates therein an indicating bulb having two electrodes in order that the user can easily know that the fuse therein is blasted. The assembly includes a crosssectionally generally rectangular housing having a central room and two side rooms, two conducting plates received in the rooms, and a fuse connected between and integrally formed with the plates, in which the housing and the plates clamp therebetween the electrodes in order to position the bulb in the central room.

U.S. Pat. No. 6,243,246, issued Jun. 5, 2001 to Lin, describes a device for warning an automotive circuit breakdown. The device comprises a housing and an apparatus located in the housing and provided with a negative conductive piece, a positive conductive piece, a fuse connecting the negative conductive piece and the positive conductive piece, a light-emitting diode fastened with the negative conductive piece, and a coiled spring fastened at one end thereof with the positive conductive piece and at other end thereof with an elastic piece. When the electric current of the automotive circuit becomes too strong, the fuse melts to break the circuit. The electric current is then made available via the coiled spring and the elastic piece to the light-emitting diode which emits light to warn of the automotive circuit breakdown.

U.S. Pat. No. 6,448,897, issued Sep. 10, 2002 to Ku, discloses a fuse assembly having a warning or indicating device. The fuse device includes two prongs secured in a casing, and a fuse member secured between the prongs. An indicating device is electrically coupled to the prongs or to the fuse member for generating a warning or an indicating signal when the fuse member is broken. The indicating device includes a pair of conductor blades electrically coupled to the prongs, and an indicating member, such as a light device or a buzzer, secured between the conductor blades for generating an indicating light or a warning sound when the fuse member is broken.

U.S. Pat. No. 5,598,138, issued Jan. 28, 1997 to Jaronczyk, Jr., puts forth a fault-indicating blade fuse, which includes a light-emitting electrical device that is positioned for ready visibility from above the fuse. The device lies within the bounds of the upper body profile of the fuse, and is so constructed and connected as to be activated upon fusion of the link, when the fuse is subjected to excessive current. In one form, a supplemental component contains a light-emitting electrical device and includes means for affixing it to the upper body portion of a fuse. Contact elements on the supplemental component establish electrical contact with the blades of the assembled fuse.

U.S. Pat. No. 4,772,219, issued Sep. 20, 1988 to Falchetti, concerns an adapter base for reed-type fuses, of the kind usually installed in fuse carriers on passenger cars, which comprises a pair of blades each provided at one end with a socket, and a microlamp having rheophores each connected electrically to a respective one of said blades. The adapter base can be retrofitted to passenger car fuse carriers and affords illumination of a burned out fuse from the time when the failure occurs.

U.S. Pat. No. 5,701,118, issued Dec. 23, 1997 to Hull, illustrates an indicator cap which is removably attachable to a prior art plug-in type fuse, and the cap having an indicator light for signaling that a fuse has blown so as to notify a user, of the blown condition of the fuse. Furthermore, we provide unique circuitry which in combination with the existing circuitry provides unusual results, and we also provide a method of use therefore.

U.S. Pat. No. 5,874,884, issued Feb. 23, 1999 to Hull, is for a blown fuse indicator circuit including a light housing containing a light source and method of use. The apparatus illuminates a light source when a fuse has blown. The apparatus includes a circuit having: a power supply source, a switch, a load, a fuse housing containing a fuse and a light housing containing a light source.

What is needed is a highly visible bipolar indicator light means with dual indicator light circuits so that polarity is not a consideration when installing a fuse.

### SUMMARY OF THE INVENTION

An object of the present invention is to provide a highly visible bipolar indicator light means independent of current polarity to light when a fuse is blown to clearly indicate that the fuse is blown no matter how the fuse is installed.

A related object of the present invention is to provide a dual LED indicator with integrated resistor attachable to a fuse so that when changing the bad fuse the mechanic or owner does not have to be conscious of the polarity because with two LED indicator circuits the single integrated resistor drops the applied voltage to the required voltage necessary to cause the LED indicator to light through one of the circuits regardless of how the fuse is inserted relative to polarity.

A further related object of the present invention is to provide dual LED indicator circuits or other dual indicator light circuits with an internal or external voltage dropping resistor indicating any open fuse line.

One more object of the present invention is to provide a dual indicator circuit which may be built directly in the fuse or attached to an existing fuse.

Yet another object of the present invention is to provide a transparent or translucent dome housing the dual LED indicator on top of the fuse or a partially or fully translucent or transparent housing around an internal dual LED indicator so that the LED is highly visible when the fuse blows.

In brief, in the present invention, when the blade fuse link has blown or opened up the current now will go through the dual LED indicator and cause it to light up showing the owner or mechanic which fuse is bad.

The dual LED indicator with an integrated resistor lights up regardless of polarity when the fuse blows, so that when changing the bad fuse a mechanic or owner does not have to be conscious of the polarity. The single integrated resistor drops the applied voltage to the required voltage necessary to cause the LED to light. The fuse can be inserted either way.

The present invention indicates any open fuse line with one of the two LED indicator circuits or other dual circuit light emitting device having an internal or external voltage dropping resistor. Bi-directional indication is possible because device has two LED indicator circuits, so polarity is not a consideration.

The dual LED indicator may be built directly in a fuse or in the case of a fuse manufactured without the indicator, a snap cap with a dual LED indicator may be snapped on the fuse.

An advantage of the present invention is that when a fuse is blown it clearly indicates that the fuse is blown no matter how the fuse is installed

Another advantage of the present invention is that, when changing the bad fuse, the mechanic or owner does not have to be conscious of the polarity because the LED indicator will light regardless of how the fuse is inserted relative to polarity.

An additional advantage of the present invention is that it may be built directly in a fuse or attached to an existing fuse.

One more advantage of the present invention is that the indicator light is highly visible when the fuse blows so that the blown fuse is easily spotted.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the blade fuse with the built-in dual LED indicator circuit and integrated resistor of the present invention built into the fuse;

FIG. 2 is an elevational view of the prior art blade fuse;

FIG. 3 is an elevational view of the blade fuse of FIG. 1;

FIG. 4 is a diagrammatic view of the electrical circuitry of the built-in dual LED indicator circuit and integrated resistor of FIG. 1;

FIG. 5 is an elevational schematic view showing a diagrammatic view of the built-in dual LED indicator circuit and integrated resistor of FIG. 1, and a schematic of the fuse link;

FIG. 6 is an elevational schematic view of the blade fuse showing the built-in dual LED indicator circuit and integrated resistor of FIG. 1 and the fuse link;

FIG. 7 is an elevational view of a blade fuse with a snap-fit dual LED indicator circuit and integrated resistor aligned for insertion in the top of the fuse;

FIG. 8 is a side elevational view of a blade fuse with a snap-fit dual LED indicator circuit and integrated resistor aligned for insertion in the top of the fuse;

FIG. 9 is a diagrammatic view of the dual LED indicator circuit and integrated resistor shown as A in FIGS. 7 and 8.

### BEST MODE FOR CARRYING OUT THE INVENTION

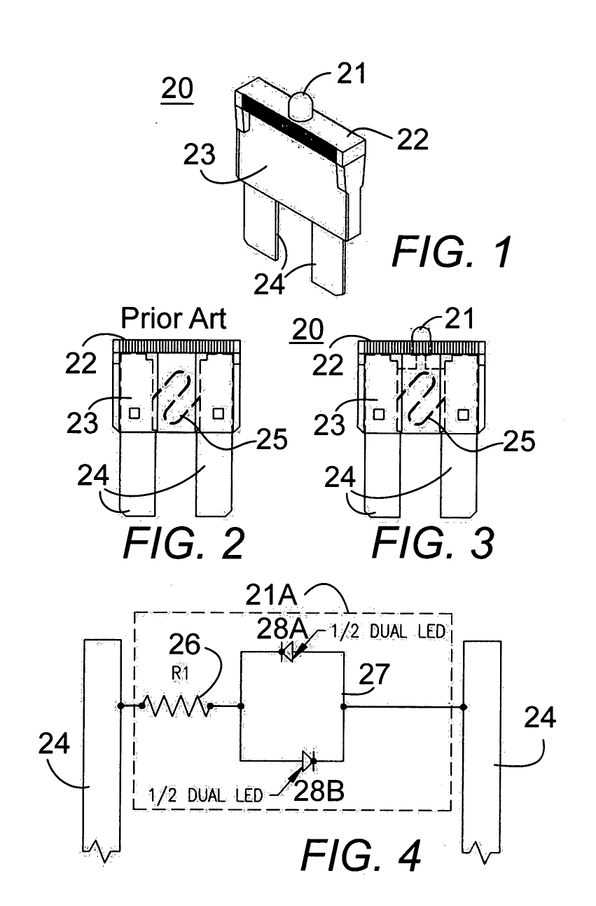

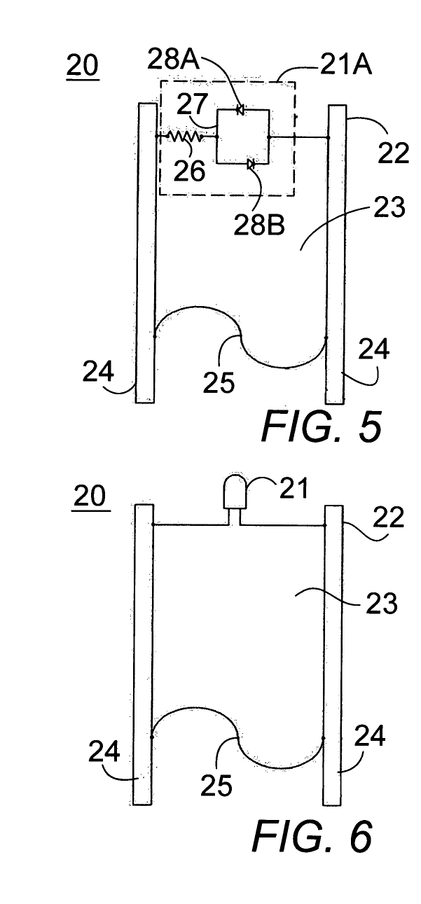

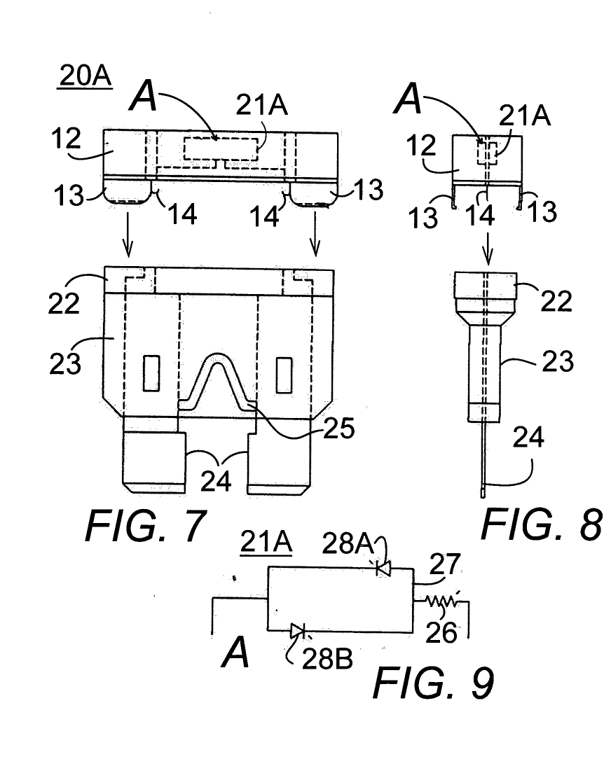

In FIGS. 1 and 3 through 9, a blown fuse indicator light device 20 and 20A comprises a dual bipolar LED indicator light circuit 21A between the blades 24 of a blade fuse in parallel with the fuse link 25. When the fuse link blows, the dual bipolar LED indicator light circuit lights to point out a blown fuse. The dual bipolar LED indicator light circuit 21A has parallel dual bipolar light emitting diode (LED) indicators 28A and 28B in series with an integrated resistor 26 for showing if the fuse is opened or blown. The dual bipolar LED indicators allow the fuse to be inserted in either direction and may be built into a blade fuse, as in FIGS. 1 and 3-6, or snapped onto a blade fuse as an attachment as in FIGS. 7 through 9.

The blown fuse indicator light device 20 for a vehicle fuse comprises two insertion blades 24, which insert into an electrical circuit to complete the circuit, and a fuse link 25 that forms an electrical connection between the blades. The fuse link is adapted to blow out when an electrical overcurrent exceeds the normal capacity of the electrical circuit in order to prevent damage of any portion of the electrical circuit.

A dual bipolar LED indicator light circuit 21A forms an electrical connection between the blades 24 in parallel with the fuse link 25. The dual bipolar indicator light circuit comprises a resistor 26 connected in series with a parallel circuit 27. The parallel circuit comprises one of a pair of alternately facing polar LEDs 28A and 28B in each of the lines of the parallel circuit to form a dual bipolar LED indicator having a single integrated resistor. The resistor drops an applied voltage between the blades to a required voltage necessary to cause one of the pair of LEDs 28A and 28B to light. The dual bipolar LEDs are configured to complete an electrical connection between the blades 24 when the fuse link is blown out, thereby lighting one or the other of the LEDs depending on the direction of a flow of electricity in the indicator light circuit, providing a blown fuse indicator light that functions regardless of the direction of flow of electricity through the fuse blades so that the fuse may be installed without regard to polarity.

In FIGS. 7 through 9, the dual LED blown fuse indicator light device 20A is fabricated into a cap 12 that has an exterior casing, which is at least partially transparent or translucent to make the internal LED visible. The cap is structured to snap onto an existing standard blade fuse, having a housing side 23 and a housing top 22. Two pair of parallel side tabs 13 snap onto and hook under the overlapping edge of the housing top 22 of the blade fuse. An electrical connector 14 from each side of the indicator light circuit 21A contacts one of the two blades 24.

In use, either a blade fuse with the built-in dual LED blown fuse indicator light device or a snap-fit cap version of the dual LED blown fuse indicator light device attached to an existing blade fuse is plugged into a fuse socket in either direction, regardless of polarity. When the fuse blows, the LED indicator lights up so the blown fuse can be easily identified, removed and replaced with another fuse.

It is understood that the preceding description is given merely by way of illustration and not in limitation of the invention and that various modifications may be made thereto without departing from the spirit of the invention as claimed.

What is claimed is:

1. A blown fuse indicator light device for a vehicle fuse, the device comprising:
a blade fuse comprising two insertion blades insertable in an electrical circuit to complete the electrical circuit and a fuse link forming an electrical connection between the blades, the fuse link adapted to blow out when an electrical overcurrent exceeds a normal capacity of the electrical circuit in order to prevent damage of any portion of the electrical circuit;
an indicator light circuit forming an electrical connection between the blades in parallel with the fuse link, the indicator light circuit comprising a resistor connected in series with a parallel circuit comprising one of a pair of alternately facing polar light emitting diodes in each of the lines of the parallel circuit to form a dual bipolar light emitting diode indicator having a single integrated resistor which drops an applied voltage between the blades to a required voltage necessary to cause one of the pair of light emitting diodes to light, the dual bipolar light emitting diode configured to complete an electrical connection between the blades when the fuse link is blown out thereby lighting one or the other of the light emitting diodes depending on the direction of a flow of electricity in the second electrical connecting element, thereby providing a blown fuse indicator light which functions regardless of a direction of flow of electricity through the fuse blades so that the fuse may be installed without regard to polarity.

2. The device of claim 1 wherein the indicator light circuit is fabricated as a part of the blade fuse.

3. The device of claim 2 further comprising a light transmissive protrusion attached exteriorly on the blade fuse housing, the protrusion housing the indicator light circuit.

4. The device of claim 1 wherein the indicator light circuit is fabricated as a part of a cap structured to snap onto a standard blade fuse.

5. The device of claim 4, comprising an exterior casing housing the indicator light circuit, the exterior casing being at least partially transparent or translucent to make the internal indicator light visible.

6. The device of claim 5, further comprising two pair of parallel side tabs protruding downwardly from the cap, the side tabs snapping onto and hooking under the overlapping edge of the blade fuse housing top.

7. The device of claim 6, further comprising a pair of electrical connectors, each one of the pair attached to one side of the indicator light circuit and contacting one of the two blades when the cap is snapped onto the blade fuse.
